(19) United States
(12) Patent Application Publication
(10) Pub. No.: US 2013/0313249 A1
(43) Pub. Date: Nov. 28, 2013

(54) METHOD FOR REGULATING THE TEMPERATURE OF AN AUTOMOTIVE VEHICLE COMPONENT AND SYSTEM FOR REGULATING THE TEMPERATURE OF THIS COMPONENT

(71) Applicants: Samuel Cregut, Saint-Remy-Les-Chevreuse (FR); Serge Loudot, Villiers Le Bacle (FR)

(72) Inventors: Samuel Cregut, Saint-Remy-Les-Chevreuse (FR); Serge Loudot, Villiers Le Bacle (FR)

(73) Assignee: Renault S.A.S., Boulogne-billancourt (FR)

(21) Appl. No.: 13/978,668

(22) PCT Filed: Dec. 20, 2011
(86) PCT No.: PCT/FR2011/053085

§ 371 Date: Aug. 12, 2013

(30) Foreign Application Priority Data
Jan. 7, 2011 (FR) 1150134

(51) Int. Cl. B60H 1/22

(52) U.S. Cl. CPC B60H 1/2221
USPC 219/630; 219/618

(57) ABSTRACT

Method for regulating the temperature of an automotive vehicle component comprising an inductive system for charging an electric battery, the inductive charging system including a coil allowing a magnetic energy to be converted into an electrical energy for charging the battery, the method involving a step of using the thermal energy produced in the coil via the Joule effect to heat the automotive vehicle component, notably a cabin of an automotive vehicle.

The present invention relates to a method for regulating the temperature of part of a motor vehicle. The invention also relates to a system for regulating the temperature of part of an automotive vehicle. Finally, the invention relates to an automotive vehicle comprising such a temperature regulating system.

In a vehicle powered by an internal combustion engine, the engine is cooled by a heat transfer fluid circuit. Because the efficiency of such engines is low, a great deal of energy is dissipated in the form of heat. During the summer, all of this heat is transferred to a heat transfer fluid and removed by a first heat exchanger usually situated on the front end of the vehicle. During the winter, the heat transfer fluid passes also through a second exchanger which is generally situated inside the dash panel and provides heating for the vehicle interior. The heat energy produced by the engine is very great and the increase in temperature is fast enough that this interior heating solution will generally suffice.

In the case of an electrically powered vehicle and, to a lesser extent, in the case of a hybrid vehicle, heating is a significant problem because the efficiencies of electric motors greatly exceed those of a combustion engine. Thus, a great many electric vehicles are fitted directly with electric resistance heaters (also known as PTC resistors) to heat the interior or, in some cases, the vehicles are fitted with an auxiliary heater (which increases costs and is a source of pollution).

The use of electric resistance heaters will, by its nature, reduce the range of the electric vehicle. It is therefore important to minimize the use of these resistance heaters so as to prioritize the range of the electric vehicle.

Electric vehicles are also known in which the battery is recharged without galvanic contact between the source of electrical energy, for example comprising the electric mains, and the electric vehicle. Electric coupling is done inductively, a first induction coil being positioned at the source of electrical energy and a second induction coil being positioned in the vehicle facing the first coil.

Such automotive vehicles are known from patents EP 715391 B1 and EP 0651404.

Patent EP 715391 B1 describes a system in which the user needs to move an electric power cable from the recharging terminal to the vehicle (in exactly the same way as refilling a fuel tank). The system is designed to keep this electric cable at a temperature that remains constant regardless of the outside temperature by circulating a fluid through it; thus in the winter the fluid has to be heated up and in the summer it potentially needs to be cooled down after it has been operating for a certain length of time. The fluid passes through the cable in one direction and returns in the other direction. The heat removed is dissipated to outside the vehicle.

Patent EP 651404 describes a system in which a transformer in the automotive vehicle is cooled and the heat is removed to outside the vehicle.

It is an object of the invention to provide a temperature regulating method that overcomes the problems mentioned hereinabove and improves the methods known from the prior art. In particular, the invention proposes a method that is simple and allows the consumption of electricity in an automotive vehicle to be optimized.

The method according to the invention regulates the temperature of a part of an automotive vehicle comprising an inductive system for charging an electric battery, the inductive charging system including a coil that allows magnetic energy to be converted into electrical energy for charging the battery. The method comprises a step of using the heat energy produced in the coil through a Joule effect to heat the part of the motor vehicle, notably a motor vehicle interior.

The step of using the heat energy produced in the coil to heat the part of the automotive vehicle may comprise a phase of thermally coupling the coil and the part via a heat transfer fluid.

The step of using the heat energy produced in the coil to heat the part of the automotive vehicle may comprise a phase of circulating the heat transfer fluid through the coil.

The invention also relates to a system for regulating the temperature of a part of an automotive vehicle comprising an inductive system for charging an electric battery. The inductive charging system includes a coil that allows magnetic energy to be converted into electrical energy for charging the battery. The regulating system comprises a means of thermally coupling the coil to the part of the automotive vehicle.

The thermal coupling means may comprise a heat transfer fluid guide duct made in the coil.

The coil may comprise a tube that makes one or more turns.

The tube may be made of an electrically conductive material, notably of metal, such as copper, and is externally covered with a layer of electrically insulating and/or thermally insulating material.

The tube may be internally covered with a layer of material, notably of an electrically insulating material.

The coil may comprise an inner first tube, notably an inner first tube made of an electrically insulating material, and an outer second tube, notably an outer second tube made of an electrically insulating and/or thermally insulating material, between which tubes is placed an electrically conductive material, notably a lap of woven or nonwoven electrically conductive strands.

The temperature regulating system may comprise a first exchanger thermally coupled to the external air surrounding the automotive vehicle.

The temperature regulating system may comprise a first bypass in parallel with the first exchanger and a first valve to regulate the fraction of heat transfer fluid passing through the first exchanger and the fraction of heat transfer fluid passing through the first bypass.

The temperature regulating system may comprise a second exchanger thermally coupled to the part to transfer heat between the heat transfer fluid and the part.

The temperature regulating system may comprise a second bypass in parallel with the second exchanger and a second valve to regulate the fraction of heat transfer fluid passing through the second exchanger and the fraction of heat transfer fluid passing through the second bypass.

The temperature regulating system may comprise a third exchanger thermally coupled to at least one component of an electric drive train of the vehicle including the battery so as to transfer heat between the heat transfer fluid and this component.

According to the invention, the automotive vehicle comprises a temperature regulating system defined hereinabove.

The attached drawings depict, by way of examples, two embodiments of a regulating system according to the invention.

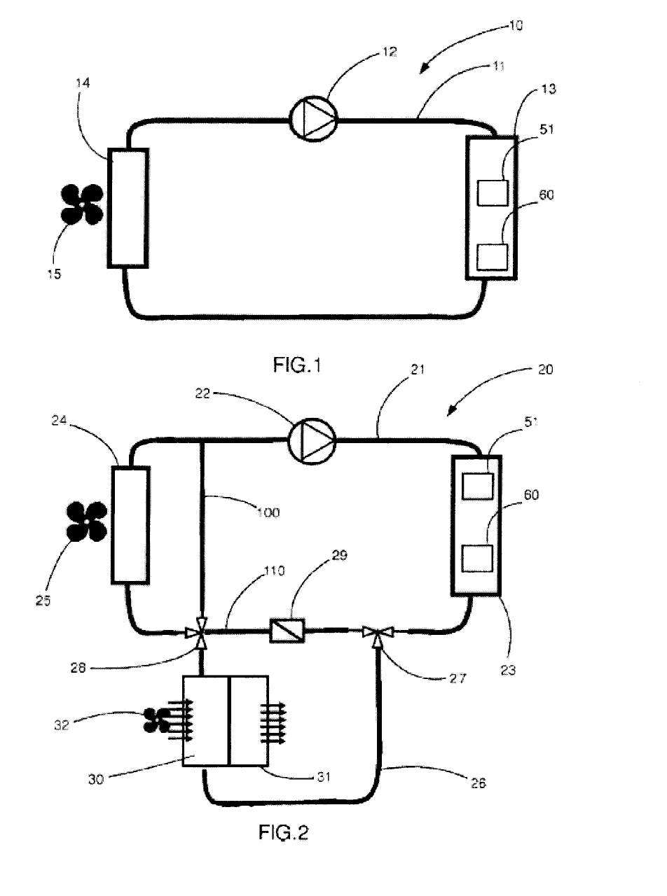

FIG. 1 is a schematic view of a first embodiment of a regulating system according to the invention.

FIG. 2 is a schematic view of a second embodiment of a regulating system according to the invention.

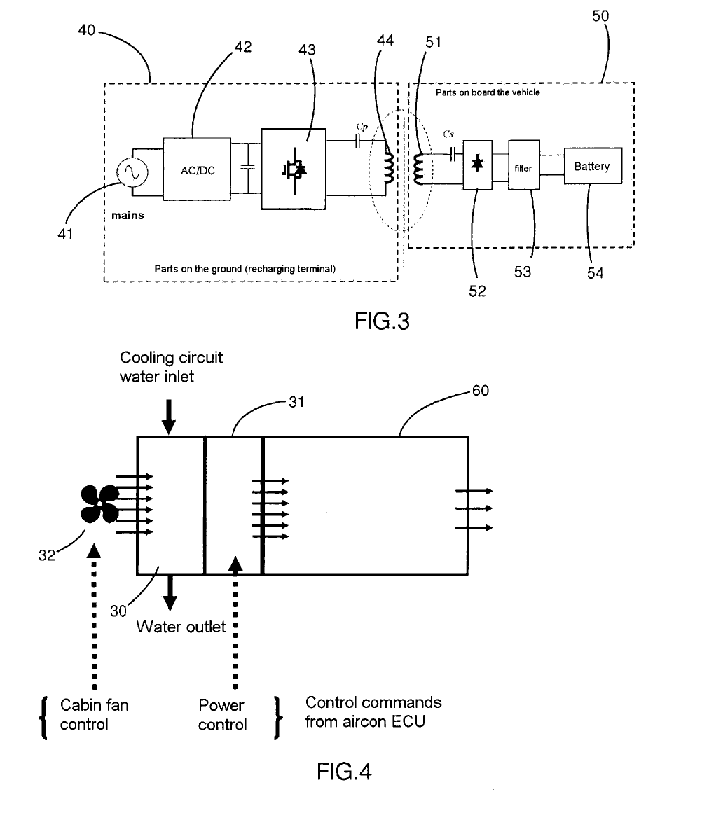

FIG. 3 is a schematic view of an embodiment of an inductive system for charging an automotive vehicle battery.

FIG. 4 is a detailed diagram of an automotive vehicle interior heating system.

FIG. 5 is a schematic cross section through a first embodiment of a secondary coil fitted to an automotive vehicle.

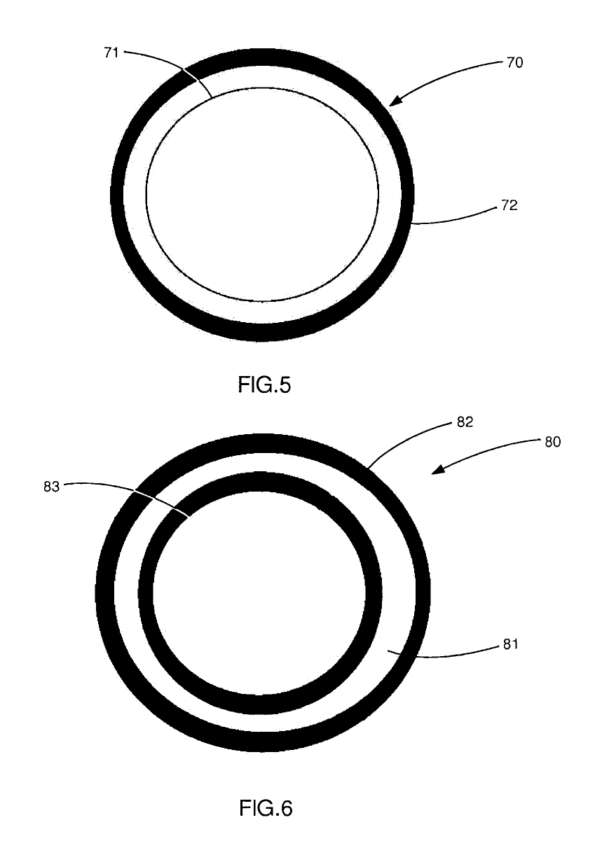

FIG. 6 is a schematic cross section through a second embodiment of a secondary coil fitted to an automotive vehicle.

A temperature regulating system 10 depicted in FIG. 1 makes it possible to regulate the temperature of a part 60 contained within a collection of parts 13 on an automotive vehicle, notably an electric automotive vehicle having an inductive recharging means. This automotive vehicle part may for example comprise an interior 60 of the automotive vehicle and/or an electric motor of the automotive vehicle and/or a battery of the automotive vehicle, notably a battery that powers a motor that propels the automotive vehicle and/or one or more electrical elements of the automotive vehicle, such as a battery charger or an inverter. This automotive vehicle part may also comprise any other element. The set of automotive vehicle parts may comprise the electric drive train or components of the electric drive train.

To allow temperature regulation, the system comprises, in addition to the set of parts 13, a heat transfer fluid duct 11, an exchanger 14 and a pump 12. The exchanger 14 may be associated with a fan unit 15 that allows fluid to be forced through the exchanger 14. The circulation of heat transfer fluid through the exchanger 14 and through the set of parts 13 is brought about using energy supplied by the pump 12. Thus, under the action of the pump 12, the heat transfer fluid exchanges heat at the exchanger 14 and at the set of parts 13 so as to cool or heat parts of the set 13, notably the part 6GY.

For preference, the electric pump is of the variable-delivery type allowing the heat transfer fluid to be circulated at a greater or lesser flow rate as required.

For preference, the exchanger is positioned on the front end of the automotive vehicle so as to allow effective cooling of the heat transfer fluid notably during dynamic operation of the automotive vehicle. The fan unit improves the exchange of heat when the automotive vehicle is stationary but running.

Moreover, as depicted in FIG. 3, the automotive vehicle equipped with the temperature regulating system according to the invention comprises an on-board system 50 comprising a battery 54 and a battery charging system including a secondary coil 51, a voltage rectifying means 52 and a filtering means 53. The battery charging system is able to convert the magnetic field generated by a primary coil 44 into a dc current for charging the battery. In particular, the secondary coil is able to convert magnetic energy into electrical energy which is then adapted for charging the battery. The secondary coil 51 forms part of the set of parts 13.

The primary coil 44 forms part of a fixed recharging station 40 for recharging electric vehicle batteries. This station is, for example, buried in the ground. It comprises a connection 41 to the electric mains, an ac/dc converter 42 and an inverter 43 connected to the primary coil. The ac signal from the electric mains is therefore rectified by the ac/dc converter before being converted into another ac signal by the inverter 43. Thus the primary coil is powered with an ac signal from the inverter and therefore emits a variable magnetic field.

These various parts allow automotive vehicle batteries to be recharged without any galvanic contact between the station and the automotive vehicle. Specifically, this recharging is done inductively, thanks to an inductive coupling between the first and second coils.

These coils are made of electrically conductive materials, notably metallic materials such as copper. These coils are generally expensive because if Joule losses are to be reduced and efficiency thus increased a sufficient amount of copper is needed.

The temperature regulating system according to the invention comprises a means for thermally coupling the secondary coil 51 to the part 60 of the automotive vehicle. Thus, the heat energy produced by Joule effect in the secondary coil 51 is used for heating the part 60.

The thermal coupling means may comprise an exchanger associated with the secondary coil 51, notably for transferring heat from the secondary coil 51 to the heat transfer fluid. The thermal coupling means may also comprise an exchanger to transfer heat from the heat transfer fluid to the part 60.

For preference, the exchanger used for transferring heat from the coil to the fluid is produced in the secondary coil 51 itself. To do this, use may be made of a thermal coupling means comprising a heat transfer fluid guide duct formed in the coil 51.

For preference, the secondary coil 51 comprises a tube that makes one or more turns.

According to a first embodiment, as depicted in FIG. 5, this tube is, for example, the tube 70 made up of a tube 71 of electrically conductive material, notably metal, such as copper or aluminum, and externally covered with a layer 72 of electrically insulating and/or thermally insulating material. The insulating material may be made of plastic, notably PET. The heat transfer fluid then circulates inside the tube 71. In this first embodiment, the exchange of heat is therefore by forced convection between the conductive material and the heat transfer fluid. The tube 70 performs a dual role of guiding fluid and conducting electricity.

According to a second embodiment, as depicted in FIG. 6, this tube is, for example, the tube 80 made up of a tube 81 of electrically conductive material, notably metal, such as copper or aluminum, and externally covered with a layer 82 of electrically insulating and/or thermally insulating material and covered internally with a layer 83 of electrically insulating material. The heat transfer fluid therefore circulates through the inside of the jacket formed by the layer 83. In this second embodiment, the exchange of heat is therefore by forced convection between the layer 83 and the heat transfer fluid through the interior layer 83. The tube 80 performs a dual role of guiding fluid and conducting electricity.

Alternatively, the tube 80 may be produced from an inner first tube, notably an inner first tube made of an electrically insulating material, and an outer second tube, notably an outer second tube made of an electrically insulating and/or thermally insulating material, between which an electrically conductive material, notably a lap of woven or nonwoven electrically conductive strands, is placed. In this third embodiment, the exchange of heat is therefore between the conductive material and the heat transfer fluid through the inner tube. The inner tube acts as a fluid guide and the conductive material acts as a conductor of electricity. Thus, the second and third embodiments differ in terms of the nature of the electrical conductor which in the second embodiment is a tube and in the third embodiment is a lap of wires or strands.

The embodiments proposed are based on circular geometries for the cross sections of the tubes used from which to make the secondary coil: that is the solution that is favored for its simplicity and cost. However, any other tube cross section is conceivable. Notably it is possible to plan for cross sections that have flats.

Having exchanged heat with the secondary coil, the heat transfer fluid continues on its way through the hydraulic circuit of the temperature regulating system to exchange heat with the part the temperature of which is to be regulated.

For example, as depicted in FIG. 4, if the part the temperature of which is to be regulated is an automotive vehicle interior, the heat transfer fluid passes through an exchanger 30 having exchanged heat with the secondary coil 51. A stream of air, for example propelled by a fan unit 32, also passes through this exchanger 30. Beforehand or afterwards, this stream of air may also pass through an electric resistance heater device 31, before being discharged into the automotive vehicle interior in order to heat it. The fan unit is controlled by a vehicle interior air conditioning computer, as is the heater device 31. Thus, operation of the fan unit and of the resistance heater device is dependent on the heat energy given up by the heat transfer fluid at the exchanger 30 and on the temperature set point to be reached in the vehicle interior. It will be noted that the more energy is given up by the heat transfer fluid in the exchanger 30, the less electrical energy is needed to operate the heater device 31. It then follows that by using the heat energy produced in the secondary coil by Joule effect it is possible to make electrical energy savings at the resistance heater device 31. This goes towards maintaining the autonomy of the battery of the motor vehicle and therefore the availability of the motor vehicle. The exchanger 30-resistance heater device 31 assembly constitutes the vehicle interior heating system. It may also include the fan unit 32.

Thus, in simplified terms:
when the battery of the automotive vehicle is on charge: the heat transfer fluid is heated by the secondary coil of the charger and used to heat the vehicle interior,
when the vehicle is running along: the heat transfer fluid is heated by the parts of the electric drive train that drives the vehicle and is used to heat the vehicle interior.

In both instances, if need be, vehicle interior heating is supplemented using the resistance heater device.

In the case of the first embodiment of temperature regulating system 10, the various heat exchanges mentioned take place in the set 13 of automotive vehicle parts.

The invention can also be applied to a second embodiment of a temperature regulating system depicted in FIG. 2. In this second embodiment of temperature regulating system, the vehicle interior heating system comprising the exchanger 30 and the heater device 31 is depicted outside of the set of parts 23 that correspond to the set of parts in FIG. 1, this set nonetheless containing the secondary coil 51. With this exception, the elements 21, 22, 23, 24 and 25 are entirely similar to the elements 11, 12, 13, 14 and 15 described hereinabove with reference to FIG. 1.

Moreover, this second embodiment comprises:
a leg 100 of heat transfer fluid duct that allows the first exchanger 24 to be bypassed, this bypass being controlled by a first three-way valve 28,
the second exchanger 30 in series with the first exchanger 24 and the set of parts 23, and
a leg 110 of heat transfer fluid duct that allows the second exchanger 30 to be bypassed, this bypass being controlled by a second three-way valve 27 and comprising a nonreturn valve 29.

The three-way valve 28 allows all the heat transfer fluid to be passed through the first exchanger 24 or allows no heat transfer fluid through the first exchanger, i.e. allows all the heat transfer fluid to be passed through the bypass or it allows a fraction of the heat transfer fluid to be passed through the first exchanger and a fraction of the heat transfer fluid to be passed through the bypass.

The three-way valve 27 allows all the heat transfer fluid to be passed through the second exchanger 30 or allows no heat transfer fluid to be passed through the second exchanger, i.e. allows all the heat transfer fluid to be passed through the bypass or allows a fraction of the heat transfer fluid to be passed through the second exchanger and a fraction of the heat transfer fluid to be passed through the bypass.

If the three-way valves are of the on/off type, then there are four modes of operation for the second embodiment of the temperature regulating system, as detailed in the table below.

| Mode | |
|---|---|
| 1 | The heat transfer fluid passes neither through the |
| | first exchanger nor through the second exchanger. |
| | This mode of operation in theory is of no benefit. |
| 2 | The heat transfer fluid passes only through the |
| | second exchanger 30; this mode is most advantageous |
| | since the heat energy transmitted to the heat |
| | transfer fluid, particularly at the secondary coil, |
| | is used to heat the vehicle interior. This is the |
| | prioritized mode (for running or when on charge). |
| 3 | The heat transfer fluid passes through both |
| | exchangers 24 and 30; it is possible to switch to |
| | this mode from mode 2, when more thermal power needs |
| | to be dissipated than the vehicle interior needs or |
| | is able to receive. |
| 4 | The heat transfer fluid passes only through the |
| | first exchanger; it may prove necessary to switch to |
| | this mode 4: |
| | if the vehicle interior air conditioning computer |
| | prevents coupling (no need for heating for example |
| | in the summer in particular). |
| | if the need for cooling continues to increase so |
| | that in order to remove the most amount of heat |
| | possible, the flow rate through the first exchanger |
| | needs to be increased to the maximum and the |
| | pressure drops in the circuit need to be reduced. |
| | This configuration may arise during running or when |
| | on charge. |

Between these various modes it is of course possible to have intermediate modes of operation in which one and/or the other of the three-way valves splits the stream of heat transfer fluid in two directions.

As seen previously, the solution proposed by the invention is that of using the heat generated by Joule effect in the secondary coil. This solution thus allows the secondary coil to be dimensioned differently because more losses in this coil can be permitted. Thus, the secondary coils can be made with a lower electrically conductive material content because losses through Joule effect prove less problematic. This results in a reduction in the mass of the vehicle and in a reduction in cost, because the conductive material used, notably copper, is heavy and expensive. This becomes all the more relevant when it is remembered that electric recharging powers used are to increase in the future (powers in excess of 10 kW are envisioned). As seen earlier, the loss in efficiency of energy transfer upon charging of the battery is compensated for by a recuperation of the energy dissipated through the Joule effect for heating a part of the automotive vehicle. Furthermore, it remains possible to remove the heat produced to outside the vehicle if the part of the vehicle no longer needs to receive that heat.

Quite clearly, and for preference, the system for regulating the temperature of the vehicle is also designed to be used when running along, the heat generated by the electric motor (and its power electronics which also heats up appreciably). It is also planned that this provision of heat be supplemented by an additional provision from a resistance heater device if need be.

In the end analysis, this temperature regulating system makes it possible to reduce the overall energy consumption of the vehicle because the additional heat to be supplied by the resistance heater device is lower. This also makes it possible to reduce the size of this heater device and the cost thereof.

In the various embodiments, the heat transfer fluid may be a mixture of water and glycol.

1. A method for regulating a temperature of a part of an automotive vehicle comprising an inductive system for charging an electric battery, the inductive charging system including a coil that allows magnetic energy to be converted into electrical energy for charging the battery, the method comprising a step of using the heat energy produced in the coil through Joule effect to heat the part of the motor vehicle, notably a motor vehicle interior.

2. The method according to claim 1, wherein the step of using the heat energy produced in the coil to heat the part of the automotive vehicle comprises a phase of thermally coupling the coil and the part via a heat transfer fluid.

3. The method according to claim 2, wherein the step of using the heat energy produced in the coil to heat the part of the automotive vehicle comprises a phase of circulating the heat transfer fluid through the coil.

4. A temperature regulating system for regulating a temperature of a part of an automotive vehicle comprising an inductive system for charging an electric battery, the inductive charging system including a coil that allows magnetic energy to be converted into electrical energy for charging the battery, the regulating system comprising a means of thermally coupling the coil to the part of the automotive vehicle.

5. The temperature regulating system according to claim 4, wherein the thermal coupling means comprises a heat transfer fluid guide duct made in the coil.

6. The temperature regulating system according to claim 4, wherein the coil comprises a tube that makes one or more turns.

7. The temperature regulating system according to claim 6, wherein the tube is made of an electrically conductive material, notably of metal, such as copper, and is externally covered with a layer of electrically insulating and/or thermally insulating material.

8. The temperature regulating system according to claim 7, wherein the tube is internally covered with a layer of material, notably of an electrically insulating material.

9. The temperature regulating system according to claim 4, wherein the coil comprises an inner first tube, notably an inner first tube made of an electrically insulating material, and an outer second tube, notably an outer second tube made of an electrically insulating and/or thermally insulating material, between which tubes is placed an electrically conductive material, notably a lap of woven or nonwoven electrically conductive strands.

10. The temperature regulating system according to claim 4, further comprising a first exchanger thermally coupled to the external air surrounding the automotive vehicle.

11. The temperature regulating system according to claim 10, further comprising a first bypass in parallel with the first exchanger and a first valve to regulate the fraction of heat transfer fluid passing through the first exchanger and the fraction of heat transfer fluid passing through the first bypass.

12. The temperature regulating system according to claim 4, further comprising a second exchanger thermally coupled to the part to transfer heat between the heat transfer fluid and the part.

13. The temperature regulating system according to claim 12, further comprising a second bypass in parallel with the second exchanger and a second valve to regulate the fraction of heat transfer fluid passing through the second exchanger and the fraction of heat transfer fluid passing through the second bypass.

14. The temperature regulating system according to claim 4, further comprising a third exchanger thermally coupled to at least one component of an electric drive train of the vehicle including the battery so as to transfer heat between the heat transfer fluid and this component.

15. An automotive vehicle comprising a temperature regulating system as claimed in claim 4.
